(19) United States
(12) Patent Application Publication
(10) Pub. No.: US 2026/0011874 A1
(43) Pub. Date: Jan. 8, 2026

(54) BUSBAR ASSEMBLY AND BATTERY MODULE

(71) Applicant: SK ON CO., LTD., Seoul (KR)

(72) Inventors: Jong Hwa LEE, Daejeon (KR); Sung Wan PARK, Daejeon (KR); Jin Kwan KIM, Daejeon (KR); Ju Young JEONG, Daejeon (KR); Yang Kyu CHOI, Daejeon (KR)

(21) Appl. No.: 19/243,696

(22) Filed: Jun. 20, 2025

(30) Foreign Application Priority Data
Jul. 4, 2024 (KR) 10-2024-0088305

(51) Int. Cl. H01M 50/503; H01M 50/204; H01M 50/507; H01M 50/516; H01M 50/528; H01M 50/533

(52) U.S. Cl. CPC H01M 50/503; H01M 50/507; H01M 50/516; H01M 50/528; H01M 50/533; H01M 50/204

(57) ABSTRACT

According to the present disclosure, provided is a battery module including: a cell assembly in which a plurality of battery cells are arranged; a module housing accommodating the cell assembly; and a busbar assembly electrically connected to the cell assembly, and the busbar assembly may include: a busbar frame including an insertion hole into which at least one cell tab of the plurality of battery cells is inserted; and a busbar which is coupled to the busbar frame, and which is disposed between the insertion holes and to which the cell tab is welded, and at least a portion of the busbar may protrude in a first direction, a direction away from the busbar frame.

### CROSS-REFERENCE TO RELATED APPLICATION(S)

This patent document claims the priority and benefits of Korean Patent Application No. 10-2024-0088305 filed on Jul. 4, 2024, the disclosure of which is incorporated herein by reference in its entirety.

### TECHNICAL FIELD

The present disclosure relates to a busbar assembly and a battery module.

### BACKGROUND

Secondary batteries are a type of energy storage device that may be charged with and discharged of electricity. Secondary batteries are widely used in various devices that use electricity as a power source. For example, secondary batteries are used as energy storage devices in various devices ranging from small devices such as mobile phones, laptop computers, and tablets to large devices such as vehicles and aircraft. Specifically, secondary batteries have been actively sought for use as a vehicle power source recently.

Secondary batteries may be classified into lead-acid batteries, nickel-cadmium batteries, nickel-hydrogen batteries, and lithium-ion batteries depending on the material of the electrode. Secondary batteries of each type may be appropriately selected according to design capacity, usage environment, and the like. Alternatively, secondary batteries may be all-solid-state batteries that use solid electrolytes instead of liquid electrolytes. Lithium-ion batteries may implement relatively high voltage and capacity compared to other types of secondary batteries. Accordingly, lithium-ion batteries are widely used in fields requiring high-density energy storage devices such as vehicle battery packs.

Secondary batteries such as lithium-ion batteries may include a cathode, anode, a separator, and an electrolyte. The cathode and anode are disposed with an insulating separator interposed therebetween, and charging or discharging may be performed by the movement of ions through the electrolyte.

Secondary batteries are manufactured as flexible pouch-type battery cells or rigid square or cylindrical can-type battery cells.

A plurality of battery cells may be disposed inside a module housing to form a battery module, and a plurality of battery modules may be disposed inside a pack housing to form a battery pack.

In addition, recently, the formation of a battery module is omitted, and a Cell to Pack (CTP) method is used to directly integrate battery cells into a battery pack and connect the battery pack to the main body frame.

Meanwhile, the cell tabs and busbars of the battery cells may be welded to be electrically connected. In this case, the cell tabs are bent at an angle close to 90° to make contact with the busbars, and welding is performed in the range in which the cell tabs and the busbars are in contact with each other. However, the resilience of the bent cell tab may cause a gap between the cell tab and the busbar, which may result in problems such as a decrease in welding quality or the need for additional means to maintain contact.

### SUMMARY

According to an aspect of the present disclosure, the quality of welding between a cell tab and a busbar may be improved.

According to an aspect of the present disclosure, the process of welding a cell tab and a busbar may be improved.

A busbar assembly and a battery module of the present disclosure may be widely applied to electric vehicles, battery charging stations, and devices within green technology fields such as solar power generation and wind power generation using other batteries. In addition, the busbar assembly and the battery module of the present disclosure may be used in eco-friendly electric vehicles, hybrid vehicles, and the like, to ameliorate the effects of climate change by suppressing air pollution and greenhouse gas emissions.

A battery module according to the present disclosure may include: a cell assembly in which a plurality of battery cells are arranged; a module housing accommodating the cell assembly; and a busbar assembly electrically connected to the cell assembly, and the busbar assembly may include: a busbar frame including an insertion hole into which at least one cell tab of the plurality of battery cells is inserted; and a busbar which is coupled to the busbar frame, and which is disposed between the insertion holes and to which the cell tab is welded, and at least a portion of the busbar may protrude in a first direction, a direction away from the busbar frame.

According to an embodiment, the busbar may include a curved surface protruding in the first direction.

According to an embodiment, the cell tab may be bent along the curved surface of the busbar.

According to an embodiment, the cell tab and the other cell tab adjacent thereto may be welded to the busbar within a range in which the cell tab and the other cell tab overlap each other.

According to another embodiment, the busbar may include a protrusion portion including a curved surface protruding in the first direction, and the busbar may include a support portion protruding in the first direction from both ends in a direction in which the cell tab is disposed.

According to another embodiment, the support portion may include a shape bent in the first direction.

According to another embodiment, the busbar may include a step portion protruding in the first direction.

According to another embodiment, the step portion may form a step with both sides of the step portion.

According to another embodiment, the busbar may include a plurality of protrusions.

According to another embodiment, the busbar may be welded to the at least two adjacent cell tabs.

According to another embodiment, the busbar may be welded to the cell tabs, two of which are disposed on each of both sides.

A busbar assembly according to the present disclosure may include: a busbar frame including an insertion hole into which a cell tab of a battery cell is inserted; and a busbar coupled to the busbar frame and disposed between the insertion holes, wherein at least a portion of the busbar may be formed to protrude in a first direction, a direction in which the cell tab is inserted, and the cell tab may be welded to the at least a portion of the busbar.

According to an embodiment, the busbar assembly may include a curved surface protruding in the first direction.

According to another embodiment, the busbar assembly may include a protrusion portion including a curved surface protruding in the first direction, and the busbar assembly may include a support portion protruding in the first direction from both ends in the direction in which the cell tab is disposed.

According to another embodiment, the busbar assembly may include a step portion protruding in the first direction.

According to an embodiment of the present disclosure, the quality of welding between a cell tab and a busbar may be improved.

According to an embodiment of the present disclosure, the process of welding a cell tab and a busbar may be improved.

### BRIEF DESCRIPTION OF DRAWINGS

Certain aspects, features, and advantages of the present disclosure are illustrated by the following detailed description with reference to the accompanying drawings.

FIG. 1 is an exploded perspective view illustrating a battery module according to the present disclosure.

FIG. 2 is a cross-sectional view illustrating a busbar assembly according to the first embodiment.

FIG. 3 is a cross-sectional view illustrating a state in which a cell tab is bent.

FIG. 4 is a cross-sectional view illustrating a state in which a bent cell tab is in contact with a busbar.

FIG. 5 is a cross-sectional view illustrating a process of welding a cell tab to a busbar.

FIG. 6 is a cross-sectional view illustrating a busbar assembly according to a second embodiment.

FIG. 7 is a cross-sectional view illustrating a busbar assembly according to a third embodiment.

FIG. 8 is a cross-sectional view illustrating a busbar assembly according to a fourth embodiment.

FIG. 9 is a cross-sectional view illustrating a state in which multiple cell tabs are welded to a busbar assembly according to the first embodiment.

FIG. 10 is a cross-sectional view illustrating a state in which multiple cell tabs are welded to a busbar assembly according to the second embodiment.

FIG. 11 is a cross-sectional view illustrating a state in which multiple cell tabs are welded to a busbar assembly according to a third embodiment.

FIG. 12 is a cross-sectional view illustrating a state in which multiple cell tabs are welded to a busbar assembly according to a fourth embodiment.

### DETAILED DESCRIPTION

Hereinafter, embodiments of the present disclosure will be described with reference to the attached drawings. For convenience, in the following description, detailed descriptions of well-known components or technical concepts of the present disclosure that are unclear will be omitted.

The technical idea of the present disclosure is not necessarily limited to the specific embodiments described below. A secondary battery or a battery cell described in this specification may include a rechargeable battery.

Hereinafter, preferred embodiments of the present disclosure will be described in detail with reference to the attached drawings. In this case, the same components in the attached drawings may be represented by the same symbols as possible. Hereinafter, a busbar assembly and a battery module according to the present disclosure will be described in detail with reference to the drawings.

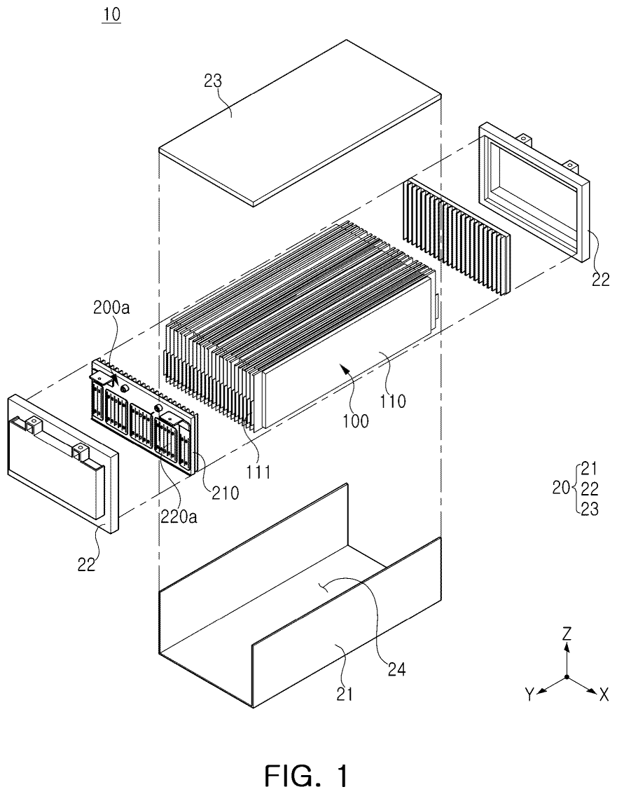

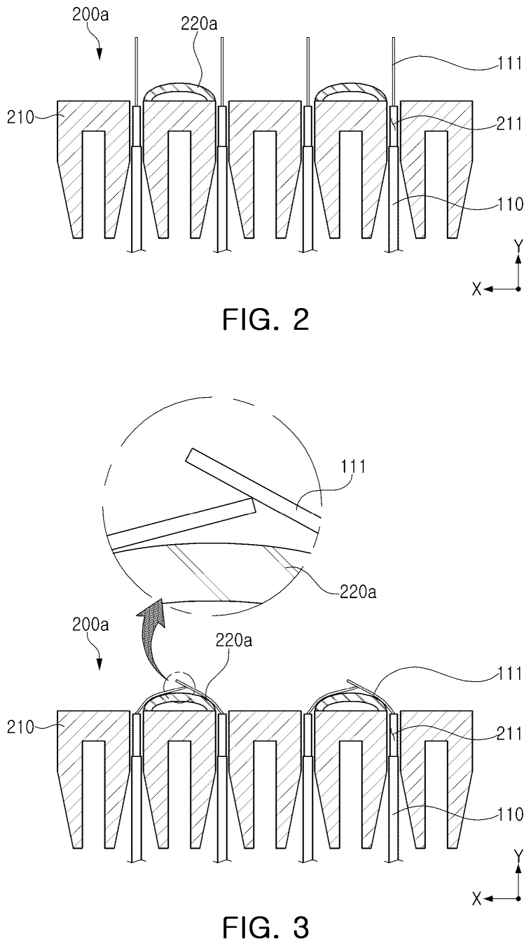

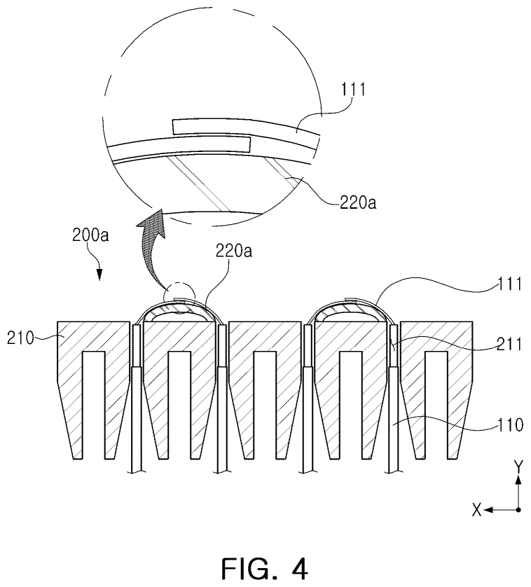

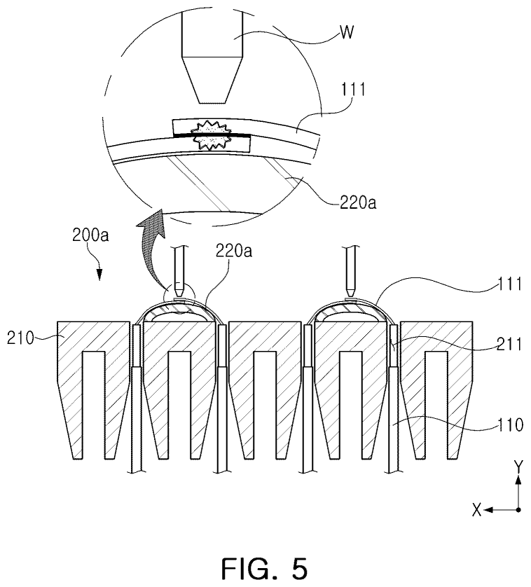

FIG. 1 is an exploded perspective view illustrating a battery module 10 according to the present disclosure, FIG. 2 is a cross-sectional view illustrating a busbar assembly 200a according to a first embodiment, FIG. 3 is a cross-sectional view illustrating a state in which a cell tab 111 is bent, FIG. 4 is a cross-sectional view illustrating a state in which a bent cell tab 111 is in contact with a busbar 220a, and FIG. 5 is a cross-sectional view illustrating a process of welding a cell tab 111 to a busbar 220a.

FIGS. 2 to 5 illustrate a process in which an inserted cell tab 111 of a busbar assembly 200a is welded to a busbar 220a, and illustrate that welding is performed in the order of FIGS. 2 to 5.

Referring to FIGS. 1 to 5, a battery module 10 according to the present disclosure may include a cell assembly 100, a module housing 20, and a busbar assembly 200a.

The cell assembly 100 may be an assembly in which a plurality of battery cells 110 are arranged.

The battery cell 110 may be formed of a lithium secondary battery, but is not limited thereto. For example, the battery cell 110 may be formed of various types of secondary batteries such as a nickel-cadmium battery, a nickel-metal hydride battery, and a nickel-hydrogen battery. The battery cell 110 may be formed of a pouch-type secondary battery. Hereinafter, a case in which a pouch-type secondary battery is used as the battery cell 110 will be described as an example. However, the present disclosure does not exclude the use of a can-type secondary battery, such as a square secondary battery or a cylindrical secondary battery, as the battery cell 110. A plurality of battery cells 110 may be arranged in a stacked state in a certain direction (X-direction). Each battery cell 110 may output or store electrical energy.

The battery cell 110 may have at least one cell tab 111 protruding in a front-back direction. The cell tab 111 may be a metallic plate electrically connected to an anode or a cathode inside the battery cell 110 to transmit electrical energy to the outside. For example, an anode tab and a cathode tab may be disposed at the front or rear of the battery cell 110, respectively. The positions of the cell tabs 111 may vary, but the present disclosure exemplifies one tab each in the front-back direction of the battery cell 110. However, the present disclosure does not exclude a form in which the cell tabs 111 protrude in a different direction of the battery cell 110.

The module housing 20 may accommodate the cell assembly 100. For example, the module housing 20 may include an accommodation space 24 accommodating the cell assembly 100. The module housing 20 may include a lower plate 21, an end plate 22, and an upper cover 23, and each of the components may be coupled to form the accommodation space 24.

For example, the lower plate 21 may be disposed in a lower portion of the battery module 10 and may cover a lower portion and left and right sides of the cell assembly 100. The end plate 22 may cover front and rear surfaces of the cell assembly 100 and may be coupled to the lower plate 21. The upper cover 23 may cover an upper portion of the cell assembly 100 and may be coupled to the lower plate 21 and the end plate 22.

The busbar assembly 200a may be electrically connected to the cell assembly 100. For example, the busbar 220a of the busbar assembly 200a may be electrically connected to the cell tab 111 of the battery cell 110. A method of electrical connection may vary, and for example, a welding method may be applied thereto.

The busbar assembly 200a may include a busbar frame 210 and a busbar 220a.

The busbar frame 210 may include an insertion hole 211. The insertion hole 211 may be a hole into which at least one cell tab 111 of the cell tabs 111 of the plurality of battery cells 110 is inserted. For example, the insertion hole 211 may include a slit shape so that the cell tab 111 passes therethrough. The number of insertion holes 211 may be formed as many as the number of cell tabs 111 of the battery cell 110. Alternatively, since it is also possible to insert two cell tabs 111 of battery cells 110 into one insertion hole 211, the insertion hole 211 may be formed to be less than the number of cell tabs 111.

The busbar frame 210 may be coupled in a direction in which the cell tabs 111 are disposed, so that the cell tab 111 may be inserted into the insertion hole 211. For example, one busbar frame 210 may be disposed at each of the front and rear of the cell assembly 100 and coupled to the cell assembly 100. In this case, the end plate 22 may be disposed on an outer side of the busbar frame 210. In other words, the busbar frame 210 may be disposed between the end plate 22 and the cell assembly 100.

The busbar 220a may be coupled to the busbar frame 210. For example, the busbar 220a may be coupled to one surface of the busbar frame 210. Specifically, the busbar 220a may be disposed on a surface disposed in a first direction (Y-direction), in one surface of the busbar frame 210. Here, the first direction (Y-direction) may be defined as a direction in which the cell tab 111 is inserted or a direction away from the busbar frame 210.

The busbar 220a may be disposed between the insertion holes 211. For example, the insertion holes 211 may be disposed in parallel in an arrangement direction (X-direction) of the battery cells 110 so as to correspond to the position of the cell tabs 111. In this case, the insertion holes 211 may be disposed at a certain interval so as to correspond to the positions of the cell tabs 111, and the busbar 220a may be disposed between the cell tabs 111.

The busbar 220a may be welded to the cell tab 111. The busbar 220a may be formed of a metallic material and may play a role in transmitting electrical energy from the battery cell 110. The busbar 220a may be welded to the cell tab 111 to be electrically connected to the cell tab 111. Various welding methods may be applied using various welding means (W). For example, laser welding may be applied as the welding method.

At least a portion of the busbar 220a may protrude in a first direction (Y-direction), the direction away from the busbar frame 210. At least a portion of the busbar 220a may include a shape protruding in the first direction (Y-direction).

For example, the busbar 220a may include a curved surface protruding in the first direction (Y-direction). Specifically, the busbar 220a may include a curved surface which has a central portion protruding the most in the first direction (Y-direction) and which gets closer to the busbar frame 210 toward both sides thereof.

Referring to FIGS. 2 to 5, a process of welding a cell tab 111 to a busbar 220a will be described.

The busbar 220a may be extended in the first direction (Y-direction) in a state of being inserted into the insertion hole 211. The busbar 220a may be welded to at least two adjacent cell tabs 111. In other words, the busbar 220a may be welded to one cell tab 111 disposed on one side of the busbar 220a and another cell tab (111) disposed on the other side of the busbar 220a.

In this case, one cell tab 111 disposed on each of both sides thereof may be bent in a direction of the busbar 220a. The cell tab 111 may be bent along the curved surface of the busbar 220a. Since the busbar 220a includes a shape in which at least a portion thereof protrudes in the first direction (Y-direction), an angle at which the cell tab 111 is bent may be reduced as compared to when the busbar 220a is formed as a flat plate. For example, when the busbar 220a is a flat plate, the cell tab 111 may need to be bent at an angle close to 90° for welding to come into contact with the busbar 220a. However, since the busbar 220a according to the present disclosure includes a shape in which the first direction (Y-direction) protrudes, the angle at which the cell tab 111 needs be bent to contact the busbar 220a may be reduced.

Another cell tab 111 adjacent to the cell tab 111 may be welded to the busbar 220a within a range in which the cell tab 111 and the busbar 220a overlap each other. That is, the cell tabs 111 disposed on the left and right sides of the busbar 220a may be bent along the busbar 220a and may then overlap each other in a central portion of the busbar 220a. In this case, each cell tab 111 and the busbar 220a may maintain contact with each other, and welding may be performed by irradiating an overlapping range with a laser, or the like.

Since the busbar 220a includes a shape protruding in the first direction (Y-direction), the cell tab 111 may be bent at an angle smaller than 90° and may be welded to the busbar 220a. Accordingly, the bent cell tab 111 undergoes relatively little deformation, and thus restoring force may also be relatively small. The cell tab 111 bent at a small angle may maintain contact with the busbar 220a even after being bent, so that the welding may be easily performed and a lifting phenomenon may also be reduced, thereby improving the quality of welding.

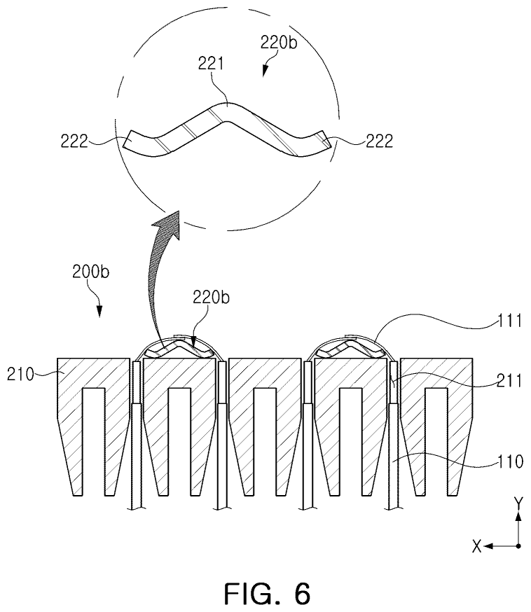

The form in which at least a portion of the busbar 220a is formed to protrude in the first direction (Y-direction) may be applied to various embodiments, and various embodiments will be described below with reference to FIGS. 6 to 12.

FIG. 6 is a cross-sectional view illustrating a busbar assembly 200b according to a second embodiment. Referring to FIG. 6, the busbar 220b may include a protrusion portion 221 and a support portion 222. The busbar 220b may include a plurality of protrusion portion 221.

The protrusion portion 221 may be a portion of the busbar 220b that includes a curved surface protruding in the first direction (Y-direction). For example, a central portion of the busbar 220b may protrude in the first direction (Y-direction) and may include a curved surface. In this case, a protruding central portion may be the protrusion portion 221.

The support portion 222 may be a portion protruding in the first direction (Y-direction) in both ends in the direction in which the cell tab 111 is disposed. A cross-section of the busbar 220b that includes the protrusion portion 221 and the support portion 222 may include a shape similar to the English letter ‘W.’ The protruding portion in the center may be the protrusion portion 221, and the protruding portions in both ends may be the support portion 222.

In this case, the cell tab 111 may be bent as if rotating about the support portion 222 as an axis. The support portion 222 of the busbar 220b may include a shape bent in the first direction (Y-direction). Since the support portion 222 acts as a fulcrum, the cell tab 111 may be easily bent. The bent cell tab 111 may be welded to the busbar 220b by contacting the protrusion portion 221. That is, the protrusion portion 221 and the cell tab 111 may be welded.

Since the protrusion portion 221 protrudes in the first direction (Y-direction), the cell tab 111 may be bent at an angle smaller than 90°.

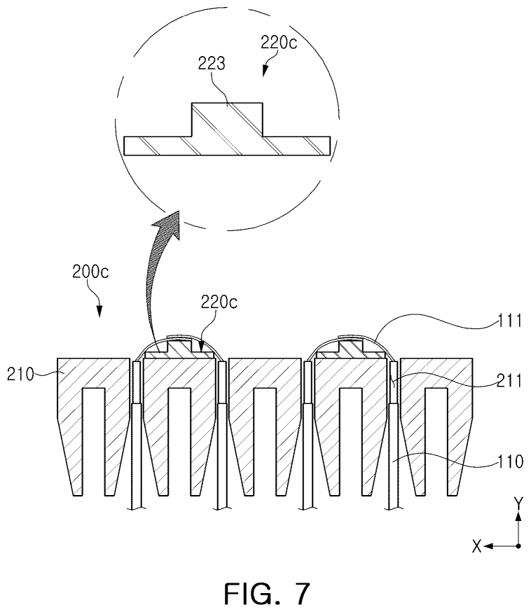

FIG. 7 is a cross-sectional view illustrating a busbar assembly 200c according to a third embodiment.

Referring to FIG. 7, a busbar 220c may include a step portion 223 protruding in the first direction (Y-direction).

The step portion 223 may form a step on each of both sides of the step portion 223. That is, one surface of the step portion 223 in the first direction (Y-direction) and one side of the other portion of the busbar 220c in the first direction (Y-direction) may not be continuously connected to each other. In other words, one surface of the step portion 223 and the other portion of the busbar 220c may form a staircase-shaped structure.

The cell tab 111 may be bent and overlapped on one surface of the step portion 223, and may be welded to the step portion 223. Since the step portion 223 protrudes in the first direction (Y-direction), the cell tab 111 may be folded at an angle less than 90°.

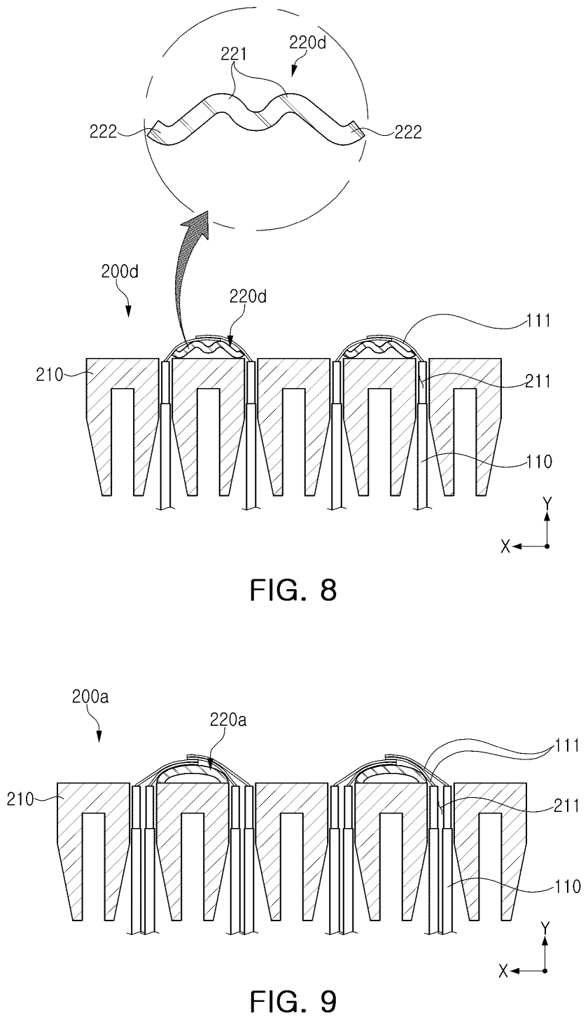

FIG. 8 is a cross-sectional view illustrating a busbar assembly 200d according to a fourth embodiment.

Referring to FIG. 8, a busbar 220d may include a plurality of protrusion portions 221.

The busbar 220d of the fourth embodiment may have a similar shape to the busbar 220b of the second embodiment. The protrusion portion 221 may be a portion protruding in the first direction (Y-direction) and including a curved surface. However, the busbar 220d of the fourth embodiment may have a plurality of protrusion portions 221 formed therein.

As the plurality of protrusion portions 221 are formed, a contact area between the cell tab 111 and the busbar 220d may be expanded. As the contact area between the cell tab 111 and the busbar 220d is expanded, the electrical resistance between the cell tab 111 and the busbar 220d may be reduced.

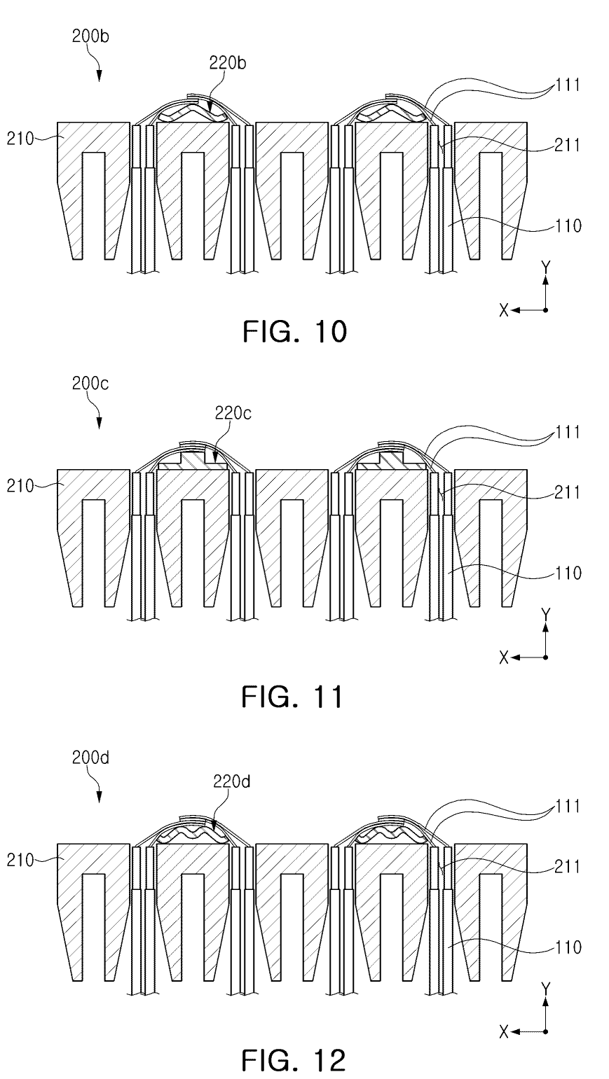

FIG. 9 is a cross-sectional view illustrating a state in which multiple cell tabs 111 are welded to a busbar assembly 200a according to the first embodiment, FIG. 10 is a cross-sectional view illustrating a state in which multiple cell tabs 111 are welded to a busbar assembly 200b according to the second embodiment, FIG. 11 is a cross-sectional view illustrating a state in which multiple cell tabs 111 are welded to a busbar assembly 200c according to the third embodiment, and FIG. 12 is a cross-sectional view illustrating a state in which multiple cell tabs 111 are welded to a busbar assembly 200d according to the fourth embodiment.

FIGS. 9 to 12 are cross-sectional views illustrating a state in which four cell tabs 111 are welded to one busbar 220a, 220b, 220c or 220d. A gap between the insertion holes 211 in FIGS. 9 to 12 may correspond to a thickness of two battery cells 110.

At least one cell tab 111 may be welded to the busbars 220a, 220b, 220c and 220d of the first to fourth embodiments. FIGS. 1 to 8 illustrate a case in which a total of two cell tabs 111 are welded one to each of the cell tabs 111 disposed on both left and right sides of the busbars 220a, 220b, 220c and 220d.

However, the number of cell tabs 111 applied to one busbar 220a, 220b, 220c or 220d may be changed, and three or more cell tabs 111 may also be applied thereto. The busbar 220d may be welded to the cell tabs 111, two of which are located on each side.

For example, as shown in FIGS. 9 to 12, the busbars 220a, 220b, 220c and 220d may be welded to two cell tabs 111 disposed on each of both sides thereof. That is, the busbars 220a, 220b, 220c and 220d may be welded to two cell tabs 111 disposed on the left side and two cell tabs 111 disposed on the right side.

In this case, two cell tabs 111 may be inserted into each of the insertion holes 211 disposed on each of both sides of the busbars 220a, 220b, 220c and 220d. Since the busbars 220a, 220b, 220c and 220d include a shape protruding in the first direction (Y-direction), welding may be easily performed even when four cell tabs 111 are applied. As the number of cell tabs 111 increases, adjacent cell tabs 111 may be influenced by each other due to restoring force of each cell tab 111. However, when applying the busbars 220a, 220b, 220c and 220d according to the present disclosure, since a plurality of cell tabs 111 only need to be bent at a small angle, this interference may be reduced, thereby easily performing the welding.

The contents described above are merely examples of applying the principles of the present disclosure, and other components may be further included without departing from the scope of the present disclosure. In addition, some components of the above-described embodiments may be deleted and implemented, and each embodiment may be implemented in combination with each other.

What is claimed is:

1. A battery module, comprising:
a cell assembly in which a plurality of battery cells are arranged;
a module housing accommodating the cell assembly; and
a busbar assembly electrically connected to the cell assembly,
wherein the busbar assembly includes:
a busbar frame including an insertion hole into which at least one cell tab of the plurality of battery cells is inserted; and
a busbar which is coupled to the busbar frame, and which is disposed between the insertion holes and to which the cell tab is welded,
wherein at least a portion of the busbar protrudes in a first direction, a direction away from the busbar frame.

2. The battery module of claim 1, wherein the busbar includes a curved surface protruding in the first direction.

3. The battery module of claim 2, wherein the cell tab is bent along the curved surface of the busbar.

4. The battery module of claim 2, wherein the cell tab and the other cell tab adjacent thereto are welded to the busbar within a range in which the cell tab and the other cell tab overlap each other.

5. The battery module of claim 1, wherein the busbar includes a protrusion portion including a curved surface protruding in the first direction, and
the busbar includes a support portion protruding in the first direction from both ends in a direction in which the cell tab is disposed.

6. The battery module of claim 5, wherein the support portion includes a shape bent in the first direction.

7. The battery module of claim 1, wherein the busbar includes a step portion protruding in the first direction.

8. The battery module of claim 7, wherein the step portion forms a step with both sides of the step portion.

9. The battery module of claim 5, wherein the busbar includes a plurality of protrusions.

10. The battery module of claim 1, wherein the busbar is welded to the at least two adjacent cell tabs.

11. The battery module of claim 10, wherein the busbar is welded to the cell tabs, two of which are disposed on each of both sides.

12. A busbar assembly, comprising:
a busbar frame including an insertion hole into which a cell tab of a battery cell is inserted; and
a busbar coupled to the busbar frame and disposed between the insertion holes,
wherein at least a portion of the busbar protrudes in a first direction, a direction in which the cell tab is inserted, and the cell tab is welded to the at least a portion of the busbar.

13. The busbar assembly of claim 12, wherein the busbar assembly includes a curved surface protruding in the first direction.

14. The busbar assembly of claim 12, wherein the busbar assembly includes a protrusion portion including a curved surface protruding in the first direction, and
the busbar assembly includes a support portion protruding in the first direction from both ends in the direction in which the cell tab is disposed.

15. The busbar assembly of claim 12, wherein the busbar assembly includes a step portion protruding in the first direction.
